(19) United States
(12) Patent Application Publication
(10) Pub. No.: US 2007/0280461 A1
(43) Pub. Date: Dec. 6, 2007

(54) Method and system for making anonymous phone calls

(76) Inventor: Qiang Du, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/448,963

(22) Filed: Jun. 6, 2006

(51) Int. Cl. H04M 3/42

(52) U.S. Cl. 379/201.01

(57) ABSTRACT

A method for allowing a first person to anonymously talk to a second person. The method includes entering an identifier that is associated with the second person and an intermediate server computer using a first phone, and then forwarding the identifier to the intermediate server computer. The identifier masks the second person's true identity. After the intermediate server computer receives the identifier, the intermediate server computer forwards a message to a second phone operated by the second person. The message includes an inquiry regarding whether or not the second person wants to talk to the first person. If the second person wants to talk to the first person, then the second person responds to the message indicating a desire to talk to the first person using the second phone, and the first and second phones are automatically connected together so that the first and second persons can talk anonymously.

### CROSS-REFERENCES TO RELATED APPLICATIONS

NOT APPLICABLE

### BACKGROUND OF THE INVENTION

In recent years, a number of Internet dating services have formed. These Internet dating services allow two potential companions to chat or communicate with each other via e-mail, instant messaging or the like. It is often the case, however, that the two potential companions would like to talk to each other on the phone, without revealing their identities to each other.

Some dating services may have thousands of members, and it would be desirable if there could be an efficient way to allow two persons to talk to each other anonymously. In addition, in some cases, one potential companion may want to call another potential companion spontaneously. It would be desirable to provide for a method and system that can allow different potential companions to talk to each other spontaneously, yet anonymously.

Embodiments of the invention address these and other problems, individually and collectively.

### SUMMARY OF THE INVENTION

Embodiments of the invention are directed to systems and methods for conducting anonymous phone calls. Embodiments can be used by two potential companions in conjunction with a dating Web site. However, embodiments of the invention may be used in any other environment where anonymity is desired. For example, embodiments of the invention may be used when two potential business partners want to talk to each other about a potential business deal, but want to remain anonymous.

One embodiment of the invention is directed to a method for allowing a first person to anonymously contact a second person. The first and second persons may be potential companions affiliated with a dating Web site. The method includes entering an identifier that is associated with the second person and an intermediate server computer using a first phone, wherein the identifier masks the second person's true identity. For example, for a second person that is named “Susan Jones”, the identifier may be “usernameSusan.datingsite.com”. This exemplary identifier masks the real name “Susan Jones” to any person that sees the identifier. The first part of the identifier is “usernameSusan” and is an alias (e.g., a username) for Susan Jones. The last part of the identifier “usernameSusan.datingsite.com”, is “datingsite.com” and is associated with an intermediate server computer. It may be an address (e.g., a URL address) associated with the intermediate server computer.

After the first person enters the identifier into his phone, the identifier is sent to the intermediate server computer. The intermediate server computer may then check the identifier or any of its parts, and the identity of the call initiator (i.e., the first person). If there are no restrictions present, the intermediate server computer forwards a request message to a second phone operated by the second person. The forwarded request message includes an inquiry regarding whether or not the second person wants to talk to the first person. This message may be displayed on the phone of the second person or may be otherwise presented to the second person (e.g., through the use of a synthesized voice).

The message may contain a second identifier. The second identifier may include a first part (e.g., an alias such as the first person's username on the Website) that is associated with the first person, and a second part that is associated with the intermediate server. Alternatively, it may contain only the first person's alias or username. For example, the request message may be, for example, “Do you want to talk to usernameJohn.datingsite.com?” or “Do you want to talk to usernameJohn?”.

After the second person responds to the message indicating a desire to talk to the first person using the second phone, the first and second phones may be automatically connected together so that the first and the second person may talk to each other using the first and second phones. The phone numbers of the first and second phones and the true identities of the first and second persons are preferably not revealed during the phone conversation.

Other embodiments of the invention may be directed to computer readable media. For example, another embodiment of the invention is directed to a computer readable medium comprising: code for entering an identifier that is associated with the second person and an intermediate server computer using a first phone, wherein the identifier masks the second person's true identity, and wherein after the intermediate server computer receives the identifier, the intermediate server computer forwards a message to a second phone operated by the second person, wherein the message includes an inquiry regarding whether or not the second person wants to talk to the first person; and code for allowing the first person to talk to the second person using the first phone after the second person responds to the message indicating a desire to talk to the first person using the second phone.

Another embodiment of the invention is directed to a method including receiving a request to talk to a second person from a first phone operated by a first person at an intermediate server computer, wherein the first person does not know the second person's true identity; after receiving the request, forwarding a message to a second phone operated by a second person, wherein the message includes an inquiry regarding whether or not the second person wants to talk to the first person; and receiving a response to the message from the second phone operated by the second person; and if the response indicates that the second person wants to talk to the first person, then automatically connecting the first phone and the second phone so that the first phone and the second phone are in communication and the first person and the second person can talk to each other

Another embodiment of the invention is directed to a computer readable medium comprising: code for receiving a request to talk to a second person from a first phone operated by a first person at an intermediate server computer, wherein the first person does not know the second person's true identity; code for forwarding a message to a second phone operated by a second person after receiving the request, wherein the message includes an inquiry regarding whether or not the second person wants to talk to the first person; and code for receiving a response to the message from the second phone operated by the second person; and code for connecting the first phone and the second phone so that the first phone and the second phone are in communication and the first person and the second person can talk to each other, if the response to the message indicates that the second person wants to talk to the first person.

These and other embodiments of the invention are described in further detail below.

### BRIEF DESCRIPTION OF THE DRAWINGS

FIG. 1 shows a block diagram of a system according to an embodiment of the invention.

FIG. 2 shows a flowchart illustrating a method according to an embodiment of the invention.

FIGS. 3 and 4 show schematic views of cell phones that can be used in embodiments of the invention.

### DETAILED DESCRIPTION

As noted above, one embodiment of the invention is directed to a method for allowing a first person to anonymously contact a second person using first and second telephones that are respectively operated by the first and second persons. The first and second persons may be potential companions affiliated with a dating Web site, although they may be affiliated with a conventional, non-Internet based dating service in other embodiments of the invention.

The method includes entering an identifier that is associated with the second person and an intermediate server computer using a first phone, wherein the identifier masks the second person's true identity. For example, for a second person that is named “Susan Jones”, the identifier may be “usernameSusan.datingsite.com”. This exemplary identifier masks the name “Susan Jones” to any person that sees the identifier “usernameSusan.datingsite.com”. The first part of the identifier may be an alias (e.g, a username) associated with the second person. The last part of the identifier “usernameSusan.datingsite.com” is “datingsite.com” and is associated with an intermediate server computer. Thus, the identifier that is entered by the first person into the first phone may contain a first portion that is associated with, but does not reveal, the name of the second person (e.g., Susan Jones), and a second portion that is associated with the address or name of an intermediate server computer.

After the first person enters the identifier on his phone, the identifier is sent to the intermediate server computer. A request message may then be generated by the intermediate server computer. The request may be a request for the second person to talk to the first person. The intermediate server computer may then check the identifier and the identity of the first person. If there are no restrictions, the intermediate server computer forwards the request message to the second phone operated by the second person.

Before forwarding the request message to the second phone operated by the second person, the intermediate server computer may check for restrictions. Such restrictions include a determination as to whether or not the first person is registered with an affiliated dating Web site, whether or not the second person has explicitly indicated that she does not want to receive phone calls (or other types of communications) from the first person, etc.

If there are no restrictions, then the intermediate server computer forwards the request message to the second phone operated by the second person. For example, a first person named John may enter the identifier “usernameSusan.datingsite.com” into a first phone, and this may result in a request message that asks a person associated with “usernameSusan” if she wants to talk on the phone. The intermediate server may then forward a request message to the second person's second phone. The new request message forwarded by the intermediate server computer may be, for example, “Do you want to talk to usernameJohn.datingsite.com?” or “Do you want to talk to usernameJohn?”. As shown by this example, the forwarded request message includes an inquiry regarding whether or not the second person wants to talk to the first person. It also includes a second identifier to identify the call initiator (i.e., the first person). The second identifier may be, for example, the username or other alias associated with the first person. It could alternatively include the username of the first person and the address of the intermediate server.

Once the request message is received by the second phone operated by the second person, the message may be displayed on the phone of the second person. For example, a display on the second phone may display the message, “Do you want to talk to usernameJohn.datingsite.com?” or “Do you want to talk to usernamejohn?” Computer code for generating such messages may reside in the second phone, and the generation of such messages may be caused by receipt of the message from the intermediate server computer. Alternatively, the actual message may be transmitted from the intermediate server computer to the second phone operated by the second person.

The second person may then respond to the message by selecting the appropriate button or buttons on the second phone, or by providing any other appropriate response (e.g., a voice response). If the second person indicates a desire to talk to the first person using the second phone, the first and second phones are automatically connected together so that the first and the second person may talk to each other using the first and second phones. The phone numbers of the first and second phones and the true identities of the first and second persons are not revealed during the phone conversation.

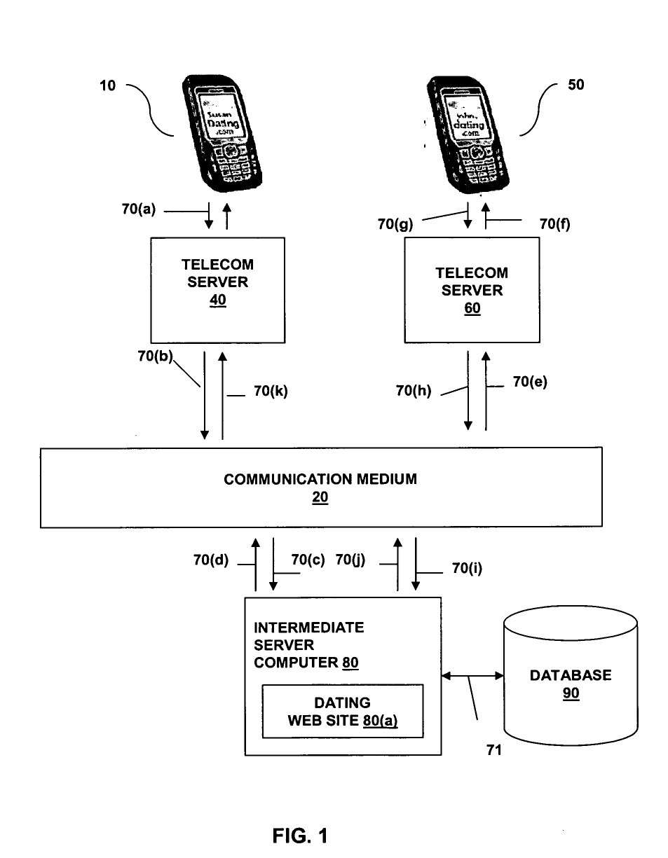

Any suitable system may be used to facilitate the above-described method. For example, FIG. 1 shows a system according to an embodiment of the invention that can be used to facilitate the above-described method. Other systems according to embodiments of the invention may use more or fewer components than are shown in FIG. 1. For example, although only two phones and one Web site is shown in FIG. 1, embodiments of the invention may include many more phones and many more Web sites in other embodiments of the invention.

The system shown in FIG. 1 includes a first phone 10 operated by a first person (not shown) and a second phone 50 operated by a second person. The first and second persons may be potential companions that are affiliated with a dating Web site. For example, both the first and second persons may be registered users of the same dating Web site. As explained above, however, the first and second persons may be potential business partners or any other types of persons who want to communicate anonymously.

The first and second phones 10, 50 may be wireless telephones, landline telephones, personal digital assistants (PDA), portable and/or personal computers, etc. Although two phones 10, 50 are shown for purposes of illustration, embodiments of the invention may include many more phones. The first and second phones 10, 50, are Internet enabled and can transmit or receive Web addresses. Entry of Web addresses into the first and second phones 10, 50 may be used to initiate phone calls in embodiments of the invention. Data for text for the various messages displayed on the phones 10, 50 may be stored in the phones 10, 50 on computer readable media residing within the phones 10, 50.

The first and second phones 10, 50, are respectively in communication with first and second telecom servers 40, 60. The first and second telecom servers 40, 60 may route data and voice communications from the first and second phones 10, 50 to the intermediate server computer 80 via the communication medium 20. In a Voice over Internet Protocol system (VOIP), the telecom servers 40, 60 could convert analog voice signals to IP packets so that the first and second phones 10, 50, have an open voice communication channel. Text messages may also be sent to the telecom servers 40, 60, and eventually to the intermediate server computer 80. Other details of exemplary computer telephony systems can be found in U.S. Pat. Nos. 6,999,431 and 5,999,609, which are herein incorporated by reference in their entirety for all purposes.

The first and second telecom servers 40, 60 are in communication with a communication medium 20. The communication medium 20 may comprise any suitable type and/or number of wired or wireless networks such as, for example, a local Ethernet, a LAN, a wireless LAN, a MAN, a WAN, or a TCP/IP network. The communication medium 20 may include the Internet. Other networks that may be included in embodiments of the invention include phone networks such as PSTN (public switched telephone network) networks. Such phone networks may be in or in communication with the communication medium 20.

An intermediate server computer 80 is in communication with the communication medium 20. The intermediate server computer 80 can run or work in conjunction with a Web site 80(a), which may be a dating Web site, or some other Web site. Although FIG. 1 shows the intermediate server computer 80 both operating the Web site 80(a) and routing phone call messages, in other embodiments, the intermediate server computer 80 may or may not operate the Web site. For example, the intermediate server computer 80 may be communication with another Web server (not shown) that operates the dating Web site.

As shown in FIG. 1, the intermediate server computer 80 may also be in communication with a database 90 that contains the registration information for the first person, the second person, and any other person that is a user of the Web site 80(a). As noted above, the database 90 may contain information such as the names, addresses (e.g., e-mail, home, etc.), and phone numbers of the first and second persons, the preferences (e.g., dating preferences, contact mode and contact time preferences of the first and second persons, etc.). Prior to talking to each other using the first and second phones 10, 50, the first and second persons may register on the dating Web site 80(a), and this registration information may be stored in the database 90.

As used herein, the term “server computer” is a powerful computer or cluster of computers that behaves as a single computer which services the requests of one or more client computers (e.g., phones). The server computer can be a mainframe computer, a minicomputer, or a minicomputer cluster. For example, the server computer may include one or more database servers and one or more Web servers.

Those of ordinary skill in the art can create other phone/server systems that can perform the methods according to embodiments of the invention.

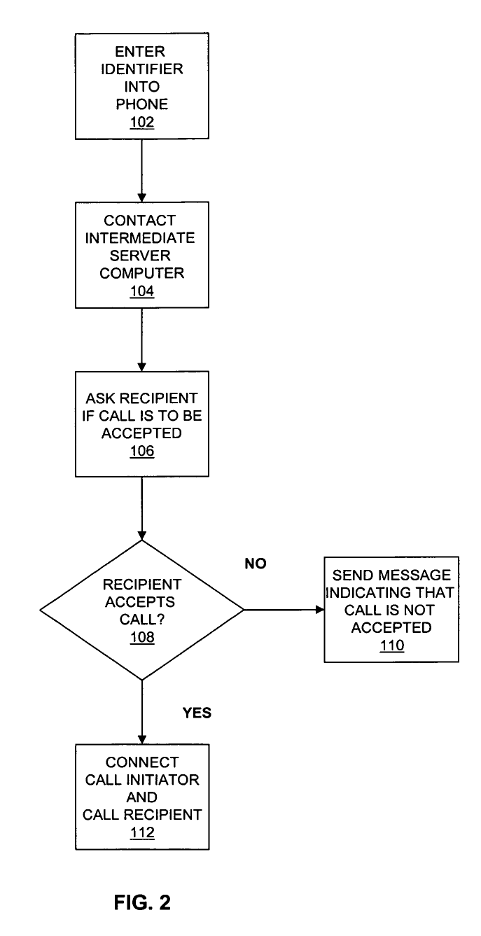

FIG. 2 shows an exemplary flowchart illustrating an embodiment of the invention. The method shown in FIG. 2 can be described with reference to FIG. 1.

Initially, a first person (e.g., John) and a second person (e.g., Susan) register as members on a dating Web site 80(a). They provide information such as their phone numbers, e-mail addresses, usernames, and other information to the Web site 80(a), and this information is stored in the database 90. In this specific example, John Smith's username may be “usernamejohn” and Susan Jones' username may be “usernameSusan”. On the Web site 80(a), John and Susan may chat or e-mail each other anonymously using their respective usernames.

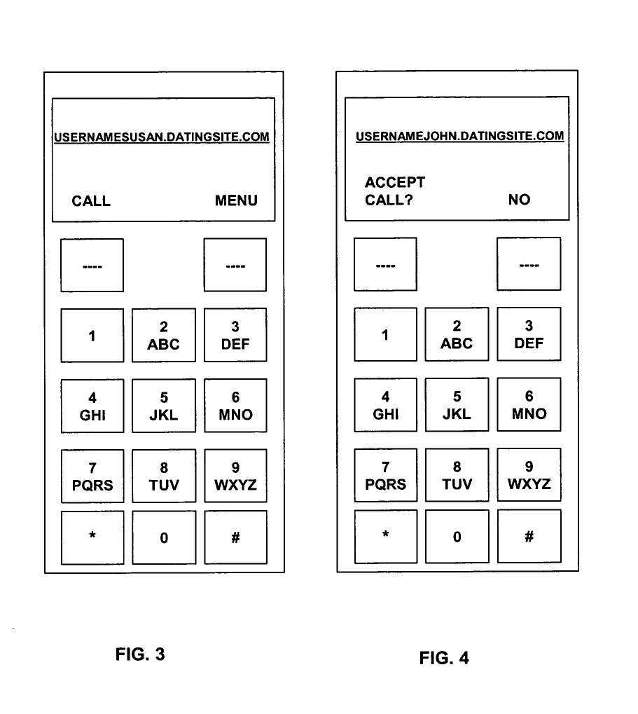

When John and Susan eventually feel comfortable with each other, one may want to call the other and talk on the phone. However, the call initiator and/or the call recipient may still want to be anonymous. For example, John may want to talk to Susan and John. John enters the identifier “usernameSusan.datingsite.com” into his phone 10 (step 102). John then selects the call button (see FIG. 3). The identifier is sent to the first telecom server 40. At the first telecom server 40, the identifier is routed to the intermediate server computer 80 via the communication medium 20 using the “datingsite.com” portion of the identifier (step 104).

The intermediate server computer 80 can verify if John and Susan can talk to each other. For example, the intermediate server computer 80 can determine if John and Susan are both subscribers to the dating service, and/or can determine if Sue has blocked phone calls or other types of communication from the alias “usernameJohn”. If this initial check by the intermediate server computer 80 is satisfactory, then the message or a related message is routed to the second telecom server 60.

The intermediate server computer 80 may then send the request message to the second phone 50 via the second telecom server 60. The request message forwarded by the intermediate server computer 80 may be, for example, “Do you want to talk to ‘usernameJohn.datingsite.com?” As shown in this example, the forwarded request message includes an inquiry regarding whether or not the second person wants to talk to the first person.

At the second telecom server 60, the message from John is routed to Susan's phone 50. Susan's phone 50 then displays the message “usernameJohn.datingsite.com”, or some other similar message (see FIG. 4) indicating that the caller is asking if the call recipient wants to talk or not (steps 106, 108). If Susan wants to talk to John, then Susan to select the button associated with “accept call”. After this, the first and second phones 10, 50 may be automatically connected together so that John and Susan can talk anonymously using their respective phones 10, 50 (step 112). At least the second person's (e.g. Susan's) identity is not revealed to the first person (e.g., John) during the phone conversation.

If Susan does not want to talk to the person associated with the alias “usernameJohn”, Susan can block the phone call, pause, or ignore it (step 110).

Embodiments of the invention have a number of advantages. First, embodiments of the invention allow two persons to talk to each other anonymously. An intermediate server computer can pre-screen whether or not they can talk to each other. The call recipient can determine whether or not she wants to talk to the call initiator, before actually speaking to the call initiator.

Any of the above-described methods or steps of such methods may be embodied as software code to be executed by a processor of the server computer or any other suitable combination of devices using any suitable computer language such as, for example, Java, C++ or Perl using, for example, conventional or object-oriented techniques. The software code may be stored as a series of instructions or commands on a computer readable medium, such as a random access memory (RAM), a read only memory (ROM), a magnetic medium such as a hard-drive or a floppy disk, or an optical medium such as a CD-ROM.

It should be understood that the present invention can be implemented in the form of control logic, in a modular or integrated manner, using software, hardware or a combination of both. Based on the disclosure and teachings provided herein, a person of ordinary skill in the art will appreciate other ways and/or methods to implement the present invention.

Any of the above-described embodiments and/or any features thereof may be combined with any other embodiment(s) and/or feature(s) without departing from the scope of the invention.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents. For example, other types of messages (e.g., SMS messages or short message service messages) may be used in embodiments of the invention, and different types of Web addresses can be used (e.g., datingsite.com/susan).

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method for a first person to anonymously contact a second person, the method comprising:
entering an identifier that is associated with the second person and an intermediate server computer into a first phone, wherein the identifier masks the second person's true identity, and wherein after the intermediate server computer receives the identifier, the intermediate server computer forwards a message to a second phone operated by the second person, wherein the message includes an inquiry regarding whether or not the second person wants to talk to the first person; and
talking to the second person using the first phone after the second person responds to the message indicating a desire to talk to the first person using the second phone,
wherein the first and second phones are automatically connected after the second person indicates the desire to talk to the first person using the second phone.

2. The method of claim 1 wherein the first phone and the second phone are wireless phones.

3. The method of claim 1 wherein the identifier comprises an address associated with the intermediate server computer.

4. The method of claim 1 wherein the intermediate server is a Web server.

5. The method of claim 1 intermediate server is a Web server, and wherein the Web server operates a dating Web site.

6. A method comprising:
receiving a request to talk to a second person from a first phone operated by a first person at an intermediate server computer, wherein the first person does not know the second person's true identity;
after receiving the request, forwarding a message to a second phone operated by a second person, wherein the message includes an inquiry regarding whether or not the second person wants to talk to the first person; and
receiving a response to the message from the second phone operated by the second person; and
if the response indicates that the second person wants to talk to the first person, then automatically connecting the first phone and the second phone so that the first phone and the second phone are in communication and the first person and the second person can talk to each other.

7. The method of claim 6 wherein the first phone and the second phone are wireless phones.

8. The method of claim 6 wherein the identifier comprises an address associated with the intermediate server computer.

9. The method of claim 6 wherein the intermediate server is a Web server, and wherein the Web server operates a dating Web site.

10. A computer readable medium comprising:
code for entering an identifier that is associated with the second person and an intermediate server computer into a first phone, wherein the identifier masks the second person's true identity, and wherein after the intermediate server computer receives the identifier, the intermediate server computer forwards a message to a second phone operated by the second person, wherein the message includes an inquiry regarding whether or not the second person wants to talk to the first person; and
code for allowing the first person to talk to the second person using the first phone after the second person responds to the message indicating a desire to talk to the first person using the second phone,
wherein the first and second phones are automatically connected after the second person indicates the desire to talk to the first person using the second phone.

11. A phone comprising the computer readable medium of claim 10.

12. The computer readable medium of claim 10 wherein the computer readable medium is in the form of one or more computer chips.

13. A computer readable medium comprising:
code for receiving a request to talk to a second person from a first phone operated by a first person at an intermediate server computer, wherein the first person does not know the second person's true identity;
code for forwarding a message to a second phone operated by a second person after receiving the request, wherein the message includes an inquiry regarding whether or not the second person wants to talk to the first person; and
code for receiving a response to the message from the second phone operated by the second person; and
code for connecting the first phone and the second phone so that the first phone and the second phone are in communication and the first person and the second person can talk to each other, if the response to the message indicates that the second person wants. to talk to the first person.

14. An intermediate server computer comprising the computer readable medium of claim 13.

15. A system comprising:
the intermediate server of claim 14;
the first phone; and
the second phone.
